(19) United States
(12) Patent Application Publication
(10) Pub. No.: US 2018/0362740 A1
(43) Pub. Date: Dec. 20, 2018

(54) RUBBER COMPOSITION FOR TIRE, TREAD AND TIRE

(71) Applicant: SUMITOMO RUBBER INDUSTRIES, LTD., Hyogo (JP)

(72) Inventors: Kenji HAMAMURA, Hyogo (JP); Tatsuya MIYAZAKI, Hyogo (JP)

(73) Assignee: SUMITOMO RUBBER INDUSTRIES, LTD., Hyogo (JP)

(21) Appl. No.: 16/007,138

(22) Filed: Jun. 13, 2018

(30) Foreign Application Priority Data
Jun. 14, 2017 (JP) 2017-117156

(51) Int. Cl. C08L 9/06; C08K 3/04; C08K 3/30; C08K 3/36; C08K 5/20; B60C 1/00

(52) U.S. Cl. CPC C08L 9/06; C08K 3/04; B60C 1/0016; C08K 3/36; C08K 5/20; C08K 3/30

(57) ABSTRACT

An object of the present invention is to provide a rubber composition being excellent in abrasion resistance and mold releasability. The rubber composition for a tire comprises 0.1 to 3.5 parts by mass of ω-9 fatty acid amide, 1 to 35 parts by mass of carbon black, 0 to 55 parts by mass of silica, and 1.5 parts by mass or less of sulfur, based on 100 parts by mass of a rubber component comprising 20% by mass or more of a butadiene rubber.

### TECHNICAL FIELD

The present invention relates to a rubber composition for a tire, a tread composed of the rubber composition for a tire and a tire having the tread.

### BACKGROUND OF THE INVENTION

Tires are required to have various performances such as grip performance and abrasion resistance. Under such a situation, there are known methods of compounding formulations such as mixing of a large amount of a filler for improving a hysteresis loss and addition of a large amount of oil for reducing a hardness. In such cases, in all-season tires and tires for wintertime, it is necessary to design tires so as to have a lower hardness, and therefore, a releasing agent from metal is added for improving releasability from a metal mold.

It is known that WB16 (available from Struktol GmbH) mainly comprising calcium salt of fatty acid as a main component, and the like are compounded as such a releasing agent from metal (JP 2015-232110 A).

### SUMMARY OF THE INVENTION

However, in conventional compounding formulations, when releasability from metal mold is intended to be improved, contrarily abrasion resistance is deteriorated. Thus no thorough solution has been achieved.

An object of the present invention is to provide a rubber composition for a tire having improved mold releasability at an unvulcanized state while maintaining abrasion resistance to be exhibited after vulcanization, a tread composed of the rubber composition for a tire and a tire having the tread.

The inventors of the present invention have made intensive studies, and as a result, have found that the above-mentioned problem can be solved by compounding a specified amount of ω-9 fatty acid amide in a rubber composition comprising a specific rubber component comprising a predetermined amount of a butadiene rubber and a predetermined amount of carbon black and also by limiting a compounding amount of sulfur, and have made further studies and thus have completed the present invention.

Namely, the present disclosure relates to:

[1] a rubber composition for a tire comprising:
0.1 to 3.5 parts by mass of ω-9 fatty acid amide,
1 to 35 parts by mass of carbon black,
0 to 55 parts by mass of silica, and
1.5 parts by mass or less of sulfur,
based on 100 parts by mass of a rubber component comprising 20% by mass or more of a butadiene rubber,
[2] the rubber composition for a tire of the above [1], wherein the rubber component further comprises a styrene-butadiene rubber,
[3] the rubber composition for a tire of the above [1] or [2], wherein a content of an acetone-soluble matter in the rubber composition after vulcanization is 15 to 35%,
[4] a tread composed of the rubber composition for a tire of any of the above [1] to [3], and
[5] a tire having the tread of the above [4].

The present invention can provide a rubber composition for a tire having improved mold releasability at an unvulcanized state while maintaining abrasion resistance to be exhibited after vulcanization, a tread composed of the rubber composition for a tire and a tire having the tread.

While not intending to be bound in any way by theory, in the present disclosure, it can be considered that in addition to improvement of abrasion resistance by blending a butadiene rubber, a synergistic improvement of abrasion resistance is achieved by blending ω-9 fatty acid amide. Namely, it is conjectured that ω-9 fatty acid amide forms hydrogen bond with carboxyl on a surface of carbon black, thereby enhancing dispersibility of carbon black. Thus, it is considered that by combination use of a butadiene rubber and ω-9 fatty acid amide, respective contributions are combined, thereby enabling synergistic improvement of abrasion resistance. Further, it is considered that ω-9 fatty acid amide forms a thin film on a surface of a metal of kneading equipment, thereby inhibiting adhesion of the rubber composition to the metal during kneading and also contributing to enhancement of processability.

### DETAILED DESCRIPTION

### <Rubber Composition for a Tire>

The rubber composition for a tire according to one embodiment comprises 0.1 to 3.5 parts by mass of ω-9 fatty acid amide, 1 to 35 parts by mass of carbon black, 0 to 55 parts by mass of silica, and 1.5 parts by mass or less of sulfur, based on 100 parts by mass of a rubber component comprising 20% by mass or more of a butadiene rubber.

### (Rubber Component)

In this embodiment, the rubber component comprises 20% by mass or more of a butadiene rubber (BR). Rubber components other than the BR are not limited particularly, and examples thereof include diene rubbers such as isoprene rubber including natural rubber (NR) and polyisoprene rubber (IR), a styrene-butadiene copolymer rubber (SBR), a styrene-isoprene-butadiene copolymer rubber (SIBR), chloroprene rubber (CR) and acrylonitrile-butadiene copolymer rubber (NBR), and butyl rubbers. One or more of these rubber components may be used in combination with BR. Particularly combination use of BR and SBR is preferable from the viewpoint of a balance of fuel efficiency, abrasion resistance, durability and wet grip performance. The rubber component consisting of BR and SBR is also preferable.

### «BR»

BR is not limited particularly, and various BRs such as a high cis-1,4-polybutadiene rubber (high-cis BR), a butadiene rubber comprising 1,2-syndiotactic polybutadiene crystals (SPB-containing BR), and a modified butadiene rubber (modified BR) can be used. These BRs may be used alone or may be used in combination of two or more thereof.

A high-cis BR is a butadiene rubber in which the content of cis-1,4 bond (cis content) is not less than 90% by mass. Examples of such high-cis BR include BR1220 manufactured by ZEON CORPORATION, BR130B and BR150B manufactured by Ube Industries, Ltd. and the like. Low-temperature property and abrasion resistance can be improved by compounding a high-cis BR. The cis content is preferably not less than 95%, more preferably not less than 96% by mass, further preferably not less than 97% by mass. It is noted that the cis content of the butadiene rubber is a value measured by an infrared absorption spectroscopy.

An example of an SPB-containing BR is not one in which 1,2-syndiotactic polybutadiene crystals are simply dispersed in the BR, but one in which 1,2-syndiotactic polybutadiene crystals are chemically bonded with the BR and dispersed therein. Examples of such SPB-containing BR include VCR-303, VCR-412 and VCR-617 manufactured by Ube Industries, Ltd. and the like.

Examples of a modified BR include a modified BR obtained by performing polymerization of 1,3-butadiene with a lithium initiator and then adding a tin compound, and further having the molecular terminals bonded with a tin-carbon bond and the like. Examples of such modified BRs include BR1250H (tin-modified) manufactured by ZEON CORPORATION, S-modified polymer (modified for silica) manufactured by Sumitomo Chemical Industry Company Limited and the like.

Among these BRs, it is preferable to use high-cis BRs from the viewpoint of excellent low temperature property and abrasion resistance.

A glass transition temperature (Tg) of the BR is preferably not less than −150° C., more preferably not less than −120° C., further preferably not less than −110° C. from the viewpoint of abrasion resistance. On the other hand, from the viewpoint of low-temperature property, the Tg of the BR is preferably not more than −60° C., more preferably not more than −70° C., further preferably not more than −80° C. The glass transition temperature of the BR is a value measured in accordance with JIS K 7121 by a differential scanning calorimetry (DSC) under the condition of a temperature elevating rate of 10° C./min.

A weight-average molecular weight (Mw) of the BR is preferably not less than 100,000, more preferably not less than 200,000, further preferably not less than 300,000 from the viewpoint of abrasion resistance. On the other hand, the Mw is preferably not more than 1,000,000, more preferably not more than 800,000, more preferably not more than 700,000 from the viewpoint of abrasion resistance. The weight-average molecular weight of the BR can be calculated with polystyrene standards based on the measured value obtained using a gel permeation chromatography (GPC) (GPC-8000 series manufactured by Tosoh Corporation, detector: differential refractometer, column: TSKGEL SUPERMALTIPORE HZ-M manufactured by Tosoh Corporation).

A content of the BR in the rubber component is not less than 20% by mass, more preferably not less than 25% by mass, further preferably not less than 28% by mass, further preferably not less than 30% by mass, further preferably not less than 40% by mass, further preferably not less than 50% by mass, further preferably not less than 55% by mass from the viewpoint of abrasion resistance and fuel efficiency. On the other hand, the content of BR is preferably not more than 80% by mass, further preferably not more than 70% by mass, further preferably not more than 65% by mass from the viewpoint of abrasion resistance, grip performance and fuel efficiency.

«SBR»

The styrene butadiene rubber (SBR) is not particularly limited, and examples thereof may include emulsion-polymerized SBR (E-SBR), solution-polymerized SBR (S-SBR) and the like, and may or may not be oil-extended. Among these, oil-extended SBR with a high molecular weight is preferable from the viewpoint of grip performance. Further, terminal-modified S-SBR and main chain-modified S-SBR that have enhanced interaction with a filler can also be used. These SBRs may be used alone or in combination.

A styrene content of the SBR is preferably not less than 12% by mass, more preferably not less than 15% by mass, further preferably not less than 20% by mass from the viewpoint of grip performance. On the other hand, the styrene content is preferably not more than 60% by mass, more preferably not more than 50% by mass, further preferably not more than 40% by mass from the viewpoint of stable grip performance. The styrene content of the SBR is a value calculated by ¹H-NMR measurement.

A vinyl content of the SBR is preferably not less than 10%, more preferably not less than 15% from the viewpoint of a hardness (Hs) of the rubber composition and grip performance. On the other hand, the vinyl content is preferably not more than 90%, more preferably not more than 70%, further preferably not more than 50%, particularly preferably not more than 40% from the viewpoint of grip performance, EB (durability) and abrasion resistance. It is noted that the vinyl content of the SBR (an amount of 1,2-bond butadiene unit) can be measured by an infrared absorption spectroscopy.

A glass transition temperature (Tg) of the SBR is preferably not less than −70° C., more preferably not less than −60° C. On the other hand, the Tg of the SBR is preferably not more than 10° C., more preferably not more than 5° C. from the viewpoint of prevention of cracking due to embrittlement at a wintertime in the Temperature Zones. It is noted that the glass transition temperature of the SBR is a value measured in accordance with JIS K 7121 by a differential scanning calorimetry (DSC) under the condition of a temperature elevating rate of 10° C./min.

A weight-average molecular weight (Mw) of the SBR is preferably not less than 400,000, more preferably not less than 500,000, further preferably not less than 550,000 from the viewpoint of grip performance. On the other hand, the weight-average molecular weight is preferably not more than 1,500,000, more preferably not more than 1,400,000, further preferably not more than 1,300,000 from the viewpoint of blowing property, namely dispersibility of filler and crosslinking uniformity. The weight-average molecular weight of the SBR can be calculated with polystyrene standards based on the measured value obtained by a gel permeation chromatography (GPC) (GPC-8000 series manufactured by Tosoh Corporation, detector: differential refractometer, column: TSKGEL SUPERMALTIPORE HZ-M manufactured by Tosoh Corporation).

A content of the SBR in the rubber component is preferably not less than 20% by mass, more preferably not less than 30% by mass, further preferably not less than 35% by mass, further preferably not less than 40% by mass, further preferably not less than 50% by mass, further preferably not less than 60% by mass, for the reason that sufficient grip performance can be obtained. On the other hand the content of the SBR is preferably not more than 80% by mass, more preferably not more than 75% by mass, further preferably not more than 73% by mass, further preferably not more than 71% by mass, further preferably not more than 70% by mass from the viewpoint of abrasion resistance and fuel efficiency. It is noted that when two or more SBRs are used in combination, the total content thereof is regarded as the content of the SBR in the rubber component of this embodiment.

### (Fillers)

The rubber composition according to this embodiment comprises fillers.

### «Carbon Black»

The rubber composition according to this embodiment at least comprises 1 to 35 parts by mass of carbon black as a filler. Any carbon black usually used for rubber compositions for a tire such as carbon black produced by an oil furnace method can be used, and examples thereof include those of GPF, HAF, ISAF, SAF grades, and the like. Among these, SAF is suitable. These carbon blacks may be used alone or may be used in combination with two or more thereof.

A nitrogen adsorption specific surface area (N₂SA) of the carbon black is preferably not less than 100 m²/g, more preferably not less than 105 m²/g, further preferably not less than 110 m²/g from the viewpoint of steering stability. Further, from the viewpoint of dispersibility, the N₂SA is preferably not more than 600 m²/g, more preferably not more than 250 m²/g, further preferably not more than 180 m²/g. It is noted that the N₂SA of the carbon black is a value determined in accordance with JIS K6217-2: 2001.

An oil absorption (OAN) of the carbon black is preferably not less than 50 ml/100 g, more preferably not less than 100 ml/100 g from the viewpoint of abrasion resistance. On the other hand, the oil absorption of the carbon black is preferably not more than 250 ml/100 g, more preferably not more than 200 ml/100 g, further preferably not more than 135 ml/100 g from the viewpoint of grip performance. It is noted that the OAN of the carbon black is measured in accordance with JIS K6217-4: 2008.

An average primary particle size of carbon black is preferably not less than 10 nm, more preferably not less than 13 nm from the viewpoint of a reinforcing effect of carbon black. Further, from the viewpoint of dispersibility of carbon black and heat build-up characteristic of the rubber composition, the average primary particle size is preferably not more than 35 nm, more preferably not more than 30 nm. It is noted that herein the average primary particle size of the carbon black can be determined by measuring particle sizes of 400 or more primary particles observed in a visual field with a transmission electron microscope and calculating an average thereof.

A content of the carbon black is 1 to 35 parts by mass based on 100 parts by mass of the rubber component from the viewpoint of exhibiting an effect of the disclosure appropriately. The content of the carbon black is preferably not less than 2 parts by mass, more preferably not less than 3 parts by mass, further preferably not less than 5 parts by mass, further preferably not less than 10 parts by mass, further preferably not less than 15 parts by mass, further preferably not less than 20 parts by mass. The content of the carbon black is preferably not more than 34 parts by mass, more preferably not more than 33 parts by mass, further preferably not more than 32 parts by mass, further preferably not more than 31 parts by mass, further preferably not more than 30 parts by mass.

### «Silica»

The rubber composition according to this embodiment comprises 0 to 55 parts by mass of silica as a filler. Namely, in other words, the rubber composition may comprise not more than 55 parts by mass of silica.

Silica is not limited particularly, and examples thereof include silica prepared by a dry method (anhydrous silica), silica prepared by a wet method (hydrous silica) and the like. For the reason that the number of silanol groups is large, silica prepared by a wet method is preferable. Silica may be used alone or may be used in combination of two or more thereof.

A nitrogen adsorption specific surface area (N₂SA) of the silica is preferably not less than 80 m²/g, more preferably not less than 100 m²/g from the viewpoint of wet grip performance and processability. Further, from the viewpoint of fuel efficiency and processability, the N₂SA of the silica is preferably not more than 250 m²/g, more preferably not more than 220 m²/g. It is noted that herein the N₂SA of the silica is a value measured by a BET method in accordance with ASTM D3037-81.

A content of the silica is preferably not more than 54 parts by mass, more preferably not more than 53 parts by mass, more preferably not more than 52 parts by mass, more preferably not more than 51 parts by mass, more preferably not more than 50 parts by mass based on 100 parts by mass of the rubber component from the viewpoint of processability. While 0 part by mass of the silica is allowable, from the viewpoint of wet grip performance, the content of the silica is preferably not less than 1 part by mass, preferably not less than 5 parts by mass, more preferably not less than 10 parts by mass, more preferably not less than 15 parts by mass, more preferably not less than 20 parts by mass, more preferably not less than 25 parts by mass, more preferably not less than 30 parts by mass.

The silica can be used in combination with a silane coupling agent. Any silane coupling agent which has been used in combination with silica in the rubber industry can be used as the silane coupling agent, and examples thereof include sulfide silane coupling agents such as Si75, Si266 (bis(3-triethoxysilylpropyl)disulfide) manufactured by Evonik Degussa and Si69 (bis(3-triethoxysilylpropyl)tetrasulfide) manufactured by Evonik Degussa; mercapto silane coupling agents (mercapto group-containing silane coupling agents) such as 3-mercaptopropyltrimethoxysilane, and NXT-Z100, NXT-Z45 and NXT manufactured by Momentive Performance Materials; vinyl silane coupling agents such as vinyltriethoxysilane; amino silane coupling agents such as 3-aminopropyltriethoxysilane; glycidoxy silane coupling agents such as γ-glycidoxypropyltriethoxysilane; nitro silane coupling agents such as 3-nitropropyltrimethoxysilane; and chloro silane coupling agents such as 3-chloropropyltrimethoxysilane, and the like. These silane coupling agents may be used alone or may be used in combination with two or more thereof. Among them, sulfide silane coupling agents and mercapto silane coupling agents are preferable from the viewpoint of their strong binding force with silica and excellent low heat build-up characteristic.

When the rubber composition comprises the silane coupling agent, the content of the silane coupling agent is preferably not less than 2 parts by mass, more preferably not less than 3 parts by mass based on 100 parts by mass of the silica from the viewpoint of improvement of dispersibility. On the other hand, the content of the silane coupling agent is preferably not more than 25 parts by mass, more preferably not more than 20 parts by mass from the viewpoint of an effect for a cost.

### «Other Fillers»

The rubber composition according to this embodiment may further comprise other fillers, and examples thereof include aluminum hydroxide, alumina (aluminum oxide), calcium carbonate, clay, talc and the like. These fillers can be used alone or in combination of two or more thereof. Among these, aluminum hydroxide is preferable from the viewpoint of excellent abrasion resistance, durability, wet grip performance and fuel efficiency.

The BET specific surface area of aluminum hydroxide is preferably 5 m²/g or more, preferably 10 m²/g or more, more preferably 12 m²/g or more from the viewpoint of wet grip performance. Further, the BET specific surface area of aluminum hydroxide is preferably 50 m²/g or less, more preferably 45 m²/g or less, further preferably 40 m²/g or less from the viewpoint of dispersibility of aluminum hydroxide, prevention of re-agglomeration thereof and abrasion resistance. It should be noted that the BET specific surface area of aluminum hydroxide as used herein is a value determined by measurement using the BET method in accordance with ASTM D3037-81.

The average particle size (D50) of aluminum hydroxide is preferably 0.1 μm or more, more preferably 0.2 μm or more, further preferably 0.3 μm or more from the viewpoint of dispersibility of aluminum hydroxide, prevention of re-agglomeration thereof and abrasion resistance. Further, the average particle size (D50) of aluminum hydroxide is preferably 3.0 μm or less, more preferably 2.0 μm or less from the viewpoint of abrasion resistance. It is noted that the average particle size (D50) as used herein refers to a particle size at a cumulative mass percentage of 50% in a particle-size distribution curve determined by a particle size distribution measurement apparatus.

When aluminum hydroxide is contained, the content of the aluminum hydroxide is preferably 1 part by mass or more, more preferably 2 parts by mass or more, further preferably 5 parts by mass or more, based on 100 parts by mass of the rubber component from the viewpoint of grip performance. Further, the content of aluminum hydroxide is preferably 50 parts by mass or less, more preferably 45 parts by mass or less, further preferably 40 parts by mass or less from the viewpoint of abrasion resistance.

### (ω-9 Fatty Acid Amide)

The rubber composition according to this embodiment is featured by comprising 0.1 to 3.5 parts by mass of ω-9 fatty acid amide (omega-9 fatty acid amide) based on 100 parts by mass of the rubber component. ω-9 fatty acid amide is blended as a processing aid. Here, omega-9 fatty acid is a kind of unsaturated fatty acid, and is a fatty acid in which a carbon-carbon double bond is located at ω-9 position (a position of a ninth bond from a methyl terminal of a fatty acid). Further, ω-9 fatty acid amide is a compound in which a carboxyl group of ω-9 fatty acid is subjected to reaction with an amino group, thereby forming an amide bond. Therefore, ω-9 fatty acid amide is a compound having a structure being different from the structures of “fatty acid monoethanolamide” and “fatty acid monoethanolamide ester” which are components contained in the releasing agent WB16 (available from Struktol GmbH). It is considered that ω-9 fatty acid amide forms a thin film on a surface of a metal (metal surface) of kneading equipment for preparing the rubber composition, thereby inhibiting the rubber composition from strongly adhering to the metal. Further, it is considered that among ω-9 fatty acid amides, oleamide is advantageous for exhibiting an effect of the disclosure since it has an excellent compatibility with the rubber component as compared with other fatty acid amides.

Examples of the ω-9 fatty acid amides include oleamide, eicosenoic acid amide, mead acid amide, euracamide, nervonic acid amide and the like. Among these, oleamide is preferable.

It is preferable that the ω-9 fatty acid amide is compounded in the form of a molten mixture with calcium stearate, for the reason that, while the molten mixture is in a solid state, it has a transparent melting point (60 to 120° C.) and is easily dispersed in the rubber composition in a kneading step, thereby further enhancing mold releasability and processability. It is considered that, by compounding the ω-9 fatty acid amide in a form of a molten mixture with calcium stearate, physical mold releasability is enhanced and a synergistic action of the physical mold releasability and mold releasability resulting from the amide bond film are exhibited, whereby effect of the disclosure is further exhibited.

The molten mixture can be prepared, for example, by heating oleamide (transparent melting point: 74° C.) and calcium stearate (transparent melting point: 154° C.) up to a melting temperature thereof while mixing the both compounds. A mixing method is not limited particularly, and there is a method of stirring the both compounds with a stirrer in a silicon oil bath with heating.

It is preferable that the molten mixture comprises 25 to 75% by mass of ω-9 fatty acid amide and 25 to 75% by mass of calcium stearate, from a point that an effect of the disclosure can be exhibited significantly, and the molten mixture comprising 40 to 60% by mass of ω-9 fatty acid amide and 40 to 60% by mass of calcium stearate is more preferable.

A content of the ω-9 fatty acid amide is not less than 0.1 part by mass, preferably not less than 0.2 part by mass, more preferably not less than 0.3 part by mass, further preferably not less than 0.4 part by mass, further preferably not less than 0.5 part by mass, further preferably not less than 0.8 part by mass, further preferably not less than 1.0 part by mass based on 100 parts by mass of the rubber component. When the content of the ω-9 fatty acid amide is less than 0.1 part by mass, there is a tendency that an effect of improving processability and mold releasability is insufficient. Further, the content of the ω-9 fatty acid amide is not more than 3.5 parts by mass, preferably not more than 3.4 parts by mass, more preferably not more than 3.3 parts by mass, further preferably not more than 3.2 parts by mass, further preferably not more than 3.1 parts by mass, further preferably not more than 3.0 parts by mass. When the content of the ω-9 fatty acid amide exceeds 3.5 parts by mass, there is a tendency that a hardness is decreased and abrasion resistance is deteriorated.

Further, the content of the ω-9 fatty acid amide is preferably not less than 1.0 part by mass, more preferably not less than 2.0 parts by mass, further preferably not less than 2.5 parts by mass from the viewpoint of wet grip performance. In this case, an upper limit of the content is 3.5 parts by mass.

### (Softening Agent)

The rubber composition according to this embodiment can comprise oil as a softening agent. Example of oil includes process oil comprising paraffinic component, naphthenic component and aromatic component. Process oil usually used in tire industry can be used suitably. Examples of process oil include Diana Process Oil PA32 (paraffinic component: 67% by mass, naphthenic component: 28% by mass, aromatic component: 5% by mass), AC-12, AC-460, AH-24, AH-58 and the like manufactured by Idemitsu Kosan Co., Ltd., Vivatec 400 (TDAE oil, paraffinic component: 49% by mass, naphthenic component: 27% by mass, aromatic component: 23% by mass) manufactured by H&R and the like. Oil can be used alone or can be used in combination of two or more thereof.

When the rubber composition comprises oil, a content thereof is preferably not less than 10 parts by mass, more preferably not less than 15 parts by mass based on 100 parts by mass of the rubber component from the viewpoint of securing on-snow performance. Further, the content of oil is preferably not more than 50 parts by mass, more preferably not more than 40 parts by mass, preferably not more than 35 parts by mass from the viewpoint of abrasion resistance. It is noted that herein, the content of the oil includes an amount of oil contained in an oil-extended rubber.

The rubber composition according to this embodiment can comprise “softening agents other than oil” (an adhesive resin, a low temperature plasticizer, a liquid polymer and the like) in addition to the above-mentioned oil or in place of the above-mentioned oil. It is preferable that a total amount of softening agents is such that an amount of an acetone-soluble matter (AE amount) in the rubber composition after vulcanization is within a range of 15 to 35%. When the amount is within such a range, there is a tendency that compatibility of processability with tire performance on a wet road surface, a dry road surface or a snow road surface can be achieved. The AE amount is preferably 18% or more, more preferably 20% or more. Further, the AE amount is preferably 30% or less, more preferably 25% or less. Any of softening agents such as an adhesive resin, a low temperature plasticizer and a liquid polymer which are usually used in tire industry can be used.

### (Vulcanizing Agent)

The rubber composition according to this embodiment comprises a vulcanizing agent, and comprises 1.5 parts by mass of a vulcanizing agent based on 100 parts by mass of the rubber component. The vulcanizing agent is not limited particularly, and those generally used in tire industry can be used. From the viewpoint that an effect of the disclosure can be obtained satisfactorily, sulfur is preferable, and powdered sulfur is more preferable.

A content of the vulcanizing agent is preferably 1.4 parts by mass or less, more preferably 1.3 parts by mass or less based on 100 parts by mass of the rubber component from the viewpoint of abrasion resistance. Further, the content of the vulcanizing agent is preferably 0.8 part by mass or more, more preferably 1.0 part by mass or more.

### (Other Compounding Agents)

In addition to the above-mentioned components, to the rubber composition of the present embodiment can be properly added other components generally used in the preparation of a rubber composition, for example, zinc oxide, stearin acid, palmitic acid, lauric acid, fatty acid zinc soap, an antioxidant, a wax, a vulcanization accelerator and the like.

### (Preparation of Rubber Composition)

The rubber composition according to the present embodiment can be prepared by a usual method. The rubber composition can be prepared, for example, by kneading the above-mentioned components except the vulcanizing agent and the vulcanization accelerator with a known kneading apparatus usually used in the rubber industry such as a Banbury mixer, a kneader or an open roll and then adding the vulcanizing agent and the vulcanization accelerator, followed by further kneading of the mixture and then carrying out vulcanization.

### <Tread, Tire>

The rubber composition according to the present embodiment can be used suitably for tire members such as a tread, an under tread, a carcass, a side wall and a bead. Especially a tire having a tread composed of the rubber composition is preferable since excellent wet grip performance and abrasion resistance are exhibited, and a racing tire and a studless tire can be provided.

The tire can be produced using the rubber composition according to the present embodiment by a usual method. Namely, the tire can be produced by subjecting the rubber composition prepared by compounding the above-mentioned compounding agents with the diene-based rubber component according to necessity, to extrusion processing to a shape of a tread or the like, and then laminating together with other tire members on a tire building machine and forming by a usual forming method, thus forming an unvulcanized tire, and heating and compressing this unvulcanized tire in a vulcanizer.

### Example

The present disclosure will be described based on Examples, but the present disclosure is not limited thereto only.

### <Various Chemicals>

A variety of chemicals used in Examples and Comparative Examples will be explained below.

SBR 1 (styrene-butadiene rubber): SBR1723 (E-SBR, styrene content: 24% by mass, vinyl content: 17%, Tg: −55° C., weight-average molecular weight: 600,000 to 650,000) manufactured by JSR Corporation SBR 2 (styrene-butadiene rubber): Tufdene 3830 (S-SBR, styrene content: 36% by mass, vinyl content: 31%, Tg: −35° C., weight-average molecular weight: 1,000,000 to 1,100,000, oil content 37.5 parts by mass) manufactured by Asahi Kasei Corporation

BR (butadiene rubber): BR150B (cis content: 97% by mass, Tg: −108° C., weight-average molecular weight: 500,000) manufactured by Ube Industries, Ltd.
CB (carbon black): N134 (N₂SA: 143 m²/g, average primary particle size: 19 nm) manufactured by Tokai Carbon Co., Ltd.
Silica: ULTRASIL VN3 (N₂SA: 175 m²/g) manufactured by Evonik Degussa
Oil: VivaTec 400 (TDAE oil) available from H&R
Processing aid 1: Oleamide: ALFLOW E-10 (transparent melting point: 74° C.) available from NOF CORPORATION. It is noted that a transparent melting point is a value measured in accordance with JIS K 0064: 1992 “Testing Methods for Melting Point and Melting Range of Chemical Products” (hereinafter the same)
Processing aid 2: WB16 (a mixture of calcium salt of fatty acid, fatty acid monoethanolamide and fatty acid monoethanolamide ester, transparent melting point: 101° C.) available from Struktol GmbH Sulfur: HK-200-5 (powdered sulfur containing 5% by mass of oil) manufactured by Hosoi Chemical Industry Co., Ltd.
Vulcanization accelerator: SANCELER NS-G (N-(tert-butyl)-2-benzothiazolsulfene amide (TBBS)) manufactured by SANSHIN CHEMICAL INDUSTRY CO., LTD.

### <Pre-Treatment of Processing Aid>

Processing aids were subjected to the following pre-treatment before use if necessary. Namely, processing aids were poured into a flask, and the flask was dipped in a silicon oil bath, followed by stirring of contents with an electronic stirrer while elevating a temperature until the contents were melted. Thereafter, the contents were taken out, cooled and pulverized using a mortar.

### Examples and Comparative Examples

### <Unvulcanized Rubber Composition>

According to compounding formulations shown in Table 1, the chemicals other than sulfur and vulcanization accelerator were kneaded with a 1.7 L enclosed Banbury mixer for 5 minutes at a discharge temperature of 160° C., to obtain a kneaded product. Further, the obtained kneaded product was kneaded again (re-milling) with the Banbury mixer at a discharge temperature of 150° C. for 4 minutes. Then, to the obtained kneaded product were added sulfur and the vulcanization accelerator, and the mixture was kneaded for 4 minutes using a biaxial open roll until the temperature reached 105° C., to obtain an unvulcanized rubber composition.

### <Vulcanized Rubber Composition for Test>

The obtained unvulcanized rubber composition was subjected to press-vulcanization at 170° C. for 12 minutes to produce a vulcanized rubber composition for test.

### <Test Tire>

The obtained unvulcanized rubber composition was extrusion-molded into a form of a tread using an extruder with an extrusion nozzle having a specific shape, and an extrudate was laminated with other tire members to form an unvulcanized tire, followed by press-vulcanization at 170° C. for 12 minutes to produce a test tire.

<Measurement of an Amount of Acetone-Soluble Matter (AE Amount) after Vulcanization>

The vulcanized rubber composition for test was cut into cubes with a side length of 1 mm to obtain 50 mg of test pieces, and an acetone-soluble matter was extracted from the inside of the test pieces in acetone (acetone of special grade available from Wako Pure Chemical Industries, Ltd.). Analysis of a component in the obtained extracted material was conducted using a gas chromatographer (available from Shimadzu Corporation). After separating the component under the conditions of 50 mL/min and 50° C. using nitrogen gas (available from Shimadzu Corporation, purity: 99.9%) as an eluent, a mass fraction of the component in the whole rubber composition was estimated using an area of an extraction peak of the component.

### <Evaluation of Performances>

The following evaluations were made using the obtained unvulcanized rubber composition, vulcanized rubber composition for test and test tires. The results of the evaluations are shown in Table 1.

### (Fuel Efficiency Index)

A loss tangent (high temperature tan δ) of each vulcanized rubber composition for test was measured with a viscoelasticity spectrometer VES (manufactured by IWAMOTO Quartz GlassLab Co., Ltd.) under the conditions of a temperature of 70° C., a frequency of 10 Hz, an initial strain of 10% and a dynamic strain of 2%. The results are indicated with an index in accordance with the following equation, assuming the tan δ of Comparative Example 1 to be 100. The larger the index is, the more excellent the fuel efficiency is. A performance target value in Table 1 is 98 or more.

(Fuel efficiency index)=(Loss tangent of Comparative Example 1)/(Loss tangent of each vulcanized rubber composition for test)×100

### (Wet Grip Performance Index)

The test tires were loaded on all wheels of a vehicle for test (FF vehicle domestically produced, displacement: 2,000 cc), and on a wet road surface, a braking distance from an initial speed of 100 km/h was measured. The results are shown by an index in accordance with the following equation, assuming the result of Comparative Example 1 to be 100. The larger the index is, the more excellent the wet grip performance is. A performance target value in Table 1 is 100 or more.

(Wet grip performance index)=(Braking distance of tires of Comparative Example 1)/(Braking distance of each test tire)×100

### (Abrasion Resistance Index 1)

A volume loss of each vulcanized rubber composition for test was measured under the conditions of a load of 50 N, a speed of 20 km/h and a slip angle of 5° using an LAT tester (laboratory abrasion and skid tester). The results are shown by an index in accordance with the following equation, assuming the result of Comparative Example 1 to be 100. The larger the index is, the more excellent the abrasion resistance is.

(Abrasion resistance index 1)=(Volume loss of vulcanized rubber composition for test of Comparative Example 1)/(Volume loss of each vulcanized rubber composition for test)×100

(Abrasion Resistance Index 2)

The test tires were loaded on all wheels of a vehicle for test (FF vehicle domestically produced, displacement: 2,000 cc), followed by 8,000 km running on a dry asphalt road. A depth of a groove of the tread portion of the tire was measured and a running distance at which the depth of the groove of the tread portion of the tire was reduced by 1 mm was calculated. The results are shown by an index in accordance with the following equation, assuming the result of Comparative Example 1 to be 100. The larger the index is, the more excellent the abrasion resistance is. A performance target value in Table 1 is 100 or more.

(Abrasion resistance index 2)=(Running distance at which the depth of a groove of each test tire was reduced by 1 mm)/(Running distance at which the depth of a groove of the test tire of Comparative Example 1 was reduced by 1 mm)×100

### (Releasability Index)

A degree of adhesion of an unvulcanized rubber composition to a rotor metal and inner walls of the 1.7 L Banbury mixer at the time of kneading with the mixer was evaluated visually and by a time for a peeling work. The results are shown by an index in accordance with the following equation, assuming the result of Comparative Example 1 to be 100. The larger the releasability index is, the more excellent the mold releasability is. A performance target value in Table 1 is 105 or more.

(Releasability index)=(Working time of Comparative Example 1)÷(Working time of each example)×100

TABLE 1

| | Comparative Example | | | | | Example | | | | |
|---|---|---|---|---|---|---|---|---|---|---|
| | 1 | 2 | 3 | 4 | 5 | 1 | 2 | 3 | 4 | 5 |
| Compounding amount | | | | | | | | | | |
| (part by mass) | | | | | | | | | | |
| SBR 1 | 30 | 30 | 30 | 30 | 30 | 30 | 30 | 30 | 15 | 30 |
| SBR 2 | 55 | 55 | 55 | 55 | 55 | 55 | 55 | 55 | 35 | 55 |
| BR | 30 | 30 | 30 | 30 | 30 | 30 | 30 | 30 | 60 | 30 |
| CB | 30 | 30 | 30 | 30 | 30 | 30 | 30 | 30 | 30 | 30 |
| Silica | 50 | 50 | 50 | 50 | 50 | 50 | 50 | 50 | 50 | 50 |
| Oil | 20 | 20 | 20 | 20 | 20 | 20 | 20 | 20 | 30 | 15 |
| Processing aid 1 | — | — | — | 4 | 2 | 2 | 1 | 3 | 2 | 2 |
| Processing aid 2 | 2 | 1 | 4 | — | — | — | — | — | — | — |
| Sulfur | 1.2 | 1.2 | 1.2 | 1.2 | 1.6 | 1.2 | 1.2 | 1.2 | 1.2 | 1.2 |
| Vulcanization accelerator | 2 | 2 | 2 | 2 | 2 | 2 | 2 | 2 | 2 | 2 |
| Acetone-soluble matter (% by mass) | 23 | 23 | 24 | 24 | 23 | 23 | 23 | 23 | 26 | 20 |
| Performance evaluation | | | | | | | | | | |
| Fuel efficiency index | 100 | 100 | 100 | 98 | 102 | 98 | 98 | 98 | 110 | 95 |
| Wet grip performance index | 100 | 100 | 100 | 102 | 97 | 101 | 100 | 102 | 80 | 100 |
| Abrasion resistance index 1 (LAT) | 100 | 102 | 100 | 102 | 95 | 105 | 102 | 104 | 120 | 104 |
| Abrasion resistance index 2 (on vehicle) | 100 | 101 | 97 | 98 | 97 | 103 | 101 | 100 | 112 | 102 |
| Releasability index | 100 | 98 | 105 | 112 | 110 | 110 | 105 | 111 | 100 | 112 |

From the results mentioned above, it is seen that the rubber composition according to the embodiment of the disclosure is excellent in mold releasability while abrasion resistance is maintained. Further it is seen that in the rubber composition according to the embodiment of the disclosure, fuel efficiency is excellent in Example 4 in which a butadiene rubber content is high, and that wet grip performance is excellent as a processing aid content increases (Examples 1, 2 and 3).

What is claimed is:

1. A rubber composition for a tire comprising:
0.1 to 3.5 parts by mass of ω-9 fatty acid amide,
1 to 35 parts by mass of carbon black,
0 to 55 parts by mass of silica, and
1.5 parts by mass or less of sulfur,
based on 100 parts by mass of a rubber component comprising 20% by mass or more of a butadiene rubber.

2. The rubber composition for a tire of claim 1, wherein the rubber component further comprises a styrene-butadiene rubber.

3. The rubber composition for a tire of claim 1, wherein an amount of an acetone-soluble matter in the rubber composition after vulcanization is 15 to 35%.

4. A tread composed of the rubber composition for a tire of claim 1.

5. A tire having the tread of claim 4.
